(19) United States
(12) Patent Application Publication
(10) Pub. No.: US 2011/0292332 A1
(43) Pub. Date: Dec. 1, 2011

(54) MANUFACTURING METHOD OF LIQUID CRYSTAL DISPLAY DEVICE

(75) Inventors: Rai YANG, Chiba (JP); Toshiro Iwata, Chosei (JP); Shinichi Soto, Mobara (JP); Tomoyuki Shiromoto, Chiba (JP); Shunsuke Yuge, Mobara (JP)

(73) Assignees: Panasonic Liquid Crystal Display Co., Ltd.; Hitachi Displays, Ltd.

(21) Appl. No.: 13/116,056

(22) Filed: May 26, 2011

(30) Foreign Application Priority Data
May 31, 2010 (JP) 2010-124305

(51) Int. Cl. G02F 1/13

(52) U.S. Cl. 349/187

(57) ABSTRACT

The present invention prevents an unrubbed portion caused by asperities formed on a surface of an alignment layer of a TFT substrate or a counter substrate. A TFT substrate is disposed on a rubbing stage and a projecting portion is formed on a surface of the TFT substrate by TFT wiring. The projecting portion on the surface causes an unrubbed portion, that is, a rubbing shadow particularly at the downstream of rubbing. In a rubbing step, two rubbing rollers that rotate in different directions are provided and the TFT substrate is rubbed in contact with the two rubbing rollers that rotate in different directions, which eliminates the influence of the rubbing shadow. Thus light leakage is prevented in black display.

### CLAIM OF PRIORITY

The present application claims priority from Japanese Patent Application JP 2010-124305 filed on May 31, 2010, the content of which is hereby incorporated by reference into this application.

### BACKGROUND OF THE INVENTION

1. Field of the Invention

The present invention relates to a display device and a manufacturing method of a liquid crystal display device which can eliminate uneven rubbing and light leakage in black display.

2. Description of the Related Art

A liquid crystal display panel used for a liquid crystal display device includes: a TFT substrate on which pixels containing pixel electrodes and thin-film transistors (TFTs) are formed in a matrix; a counter substrate that is opposed to the TFT substrate and has color filters aligned with the respective pixel electrodes of the TFT substrate; and a liquid crystal interposed between the TFT substrate and the counter substrate. An image is formed by controlling the light transmittance of liquid crystal molecules in each pixel.

In the liquid crystal display device, the liquid crystal molecules are initially oriented by alignment layers formed on the TFT substrate and the counter substrate. The state of the initial orientations of the liquid crystal molecules is changed by an electric field that is formed between the pixel electrodes and counter electrodes by a video signal applied to the pixel electrodes, so that an amount of light passing through the liquid crystal display panel is controlled. The initial orientations of liquid crystal molecules are specified by rubbing the alignment layers.

Pixels have been reduced in size in response to the demand for compact liquid crystal display devices having high definition screens. Thus asperities formed by video signal lines and the pixel electrodes on the TFT substrate may cause uneven rubbing. The substrate is rubbed by rotating a rubbing roller wrapped with a fibrous rubbing cloth.

At this point, asperities on the surface of the substrate may cause uneven rubbing depending on the direction of rotation of the rubbing roller. Japanese Patent Laid-Open No. 2001-166310 describes a technique in which a rubbing stage having a substrate placed thereon reciprocates to rub the substrate twice in one direction and the opposite direction, so that the substrate is evenly rubbed.

### SUMMARY OF THE INVENTION

FIG. 9 is a schematic drawing showing a rubbing step of the related art. In FIG. 9, a TFT substrate 100 is placed on a rubbing stage 30. The TFT substrate 100 has various wires that form asperities. In FIG. 9, the state of the asperities is represented by TFT wiring 20. The TFT wiring 20 represents wiring formed on the TFT substrate 100 and does not indicate a specific wire. Actually, an alignment layer 109 is formed on the TFT wiring 20 but is omitted in FIG. 9.

The rubbing stage 30 having the TFT substrate 100 moves in the direction of an arrow. A rubbing roller 10 rotating in direction R1 is pressed to the TFT substrate 100, so that the surface of the TFT substrate 100 is rubbed by fibers 11 on a rubbing cloth 12 on the surface of the rubbing roller 10.

FIG. 10 is a detailed drawing showing a state of rubbing. In FIG. 10, the TFT substrate 100 is placed on the rubbing stage 30 and the rubbing stage 30 moves in the direction of an arrow. The rubbing roller 10 rotates in R1 direction and the surface of the TFT substrate 100 is rubbed by the fibers 11 of the rubbing cloth 12.

On the TFT substrate 100, asperities represented by the TFT wiring 20 are formed. FIG. 10 shows the behaviors of the fibers 11 of the rubbing cloth 12 in the presence of asperities represented by the TFT wiring 20. In FIG. 10, upstream of the rotation direction of the rubbing roller 10, the asperities represented by the TFT wiring 20 have only a small unrubbed area, that is, a small rubbing shadow, whereas downstream of the rotation of the rubbing roller 10, the asperities have a large unrubbed area, that is, a large rubbing shadow.

Since liquid crystal molecules are not oriented in the area of the rubbing shadow, light leaks in black display on a screen, leading to a lower contrast. Thus, in the rubbing step, it is important to reduce the area of the rubbing shadow shown in FIG. 10.

Disadvantageously, in the rubbing method of Japanese Patent Laid-Open No. 2001-166310, the rubbing stage 30 reciprocates and the rubbing time is at least twice as long as that of the related art. Further, in the case where other steps and the rubbing step are provided in-line, the layout may become defective. Another disadvantage is that the orientations of the fibers 11 of the rubbing cloth 12 cannot be optimally set relative to a backward rotation of the rubbing roller 10.

The present invention provides a liquid crystal display device that reduces the area of a rubbing shadow, substantially eliminates an area where liquid crystal molecules are not oriented, causes no light leakage in black display, and achieves a high contrast. Moreover, the present invention provides a liquid crystal display device that can substantially eliminate an area where liquid crystal molecules are not oriented, without increasing a rubbing time. Furthermore, the present invention provides a rubbing step of fabricating the liquid crystal display device with high consistency with the previous and subsequent steps.

The present invention has been made to solve the foregoing problems. The specific solutions will be discussed below. In the case where a substrate surface has asperities, a so-called rubbing shadow appears. As the range of the rubbing shadow increases, liquid crystal molecules have a more noticeable alignment defect. The rubbing shadow is larger at the downstream of rubbing than the upstream of rubbing because of the rotation direction of the rubbing roller.

According to the present invention, two rubbing rollers rotating in different directions are disposed in parallel in a rubbing step. The two rubbing rollers continuously rub a TFT substrate or counter electrodes. Since the two rubbing rollers rotate in different directions, the rubbing shadows can be reduced by compensation of the two rubbing rollers. Moreover, the present invention can optimize, e.g., the orientations of the fibers of rubbing clothes on the two rubbing rollers.

According to the present invention, the two rubbing rollers are disposed and a rubbing stage having a substrate placed thereon may be moved only in one direction as in the related art. Thus the influence of a rubbing shadow can be eliminated without increasing the rubbing time. Further, the rubbing clothes on the two rubbing rollers or conditions including the orientations of the fibers of the rubbing clothes are optimized for each of the rollers, so that the influence of a rubbing shadow can be further reduced.

According to the present invention, the rubbing stage may be moved only in one direction, so that the rubbing step and the previous and subsequent steps can be easily arranged in-line. Thus the manufacturing process can be rationally laid out.

The present invention can provide a liquid crystal display device that does not leak light from a backlight in black display and has a high contrast. Further, the present invention eliminates the need for increasing the rubbing time, thereby achieving a liquid crystal display device with a high contrast while suppressing an increase in manufacturing cost.

### BRIEF DESCRIPTION OF THE DRAWINGS

FIG. 1 is a cross-sectional view schematically showing a rubbing step according to an embodiment of the present invention;

FIG. 2 is a perspective view showing the rubbing step according to the embodiment of the present invention;

FIG. 3 is a schematic diagram showing the principle of the embodiment of the present invention;

FIG. 4 is a cross-sectional view showing a TFT substrate of an IPS liquid crystal display device;

FIG. 5 is a plan view showing an IPS pixel part;

FIG. 6 shows an example of a cross-sectional view of a part containing an IPS video signal line;

FIG. 7 is a cross-sectional view showing a TN liquid crystal display device;

FIG. 8 is a cross-sectional view showing a liquid crystal display device in which color filters are formed on a TFT substrate;

FIG. 9 is a cross-sectional view schematically showing a rubbing step of the related art; and

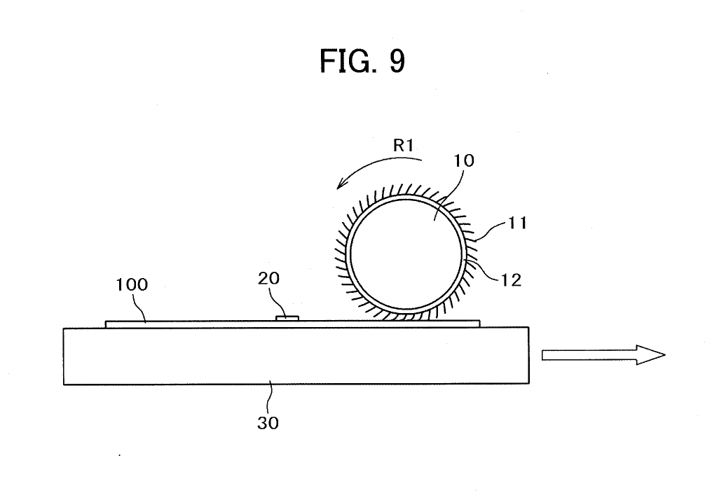

FIG. 10 is a schematic drawing showing a problem in the rubbing step of the related art.

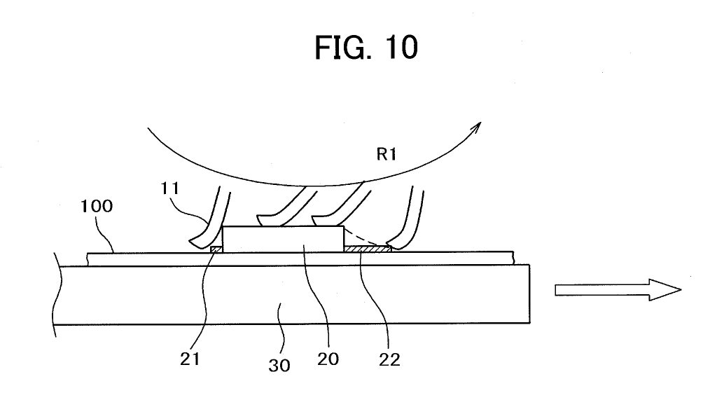

### DETAILED DESCRIPTION OF THE INVENTION

The contents of the present invention will be specifically described below according to an embodiment of the present invention.

### First Embodiment

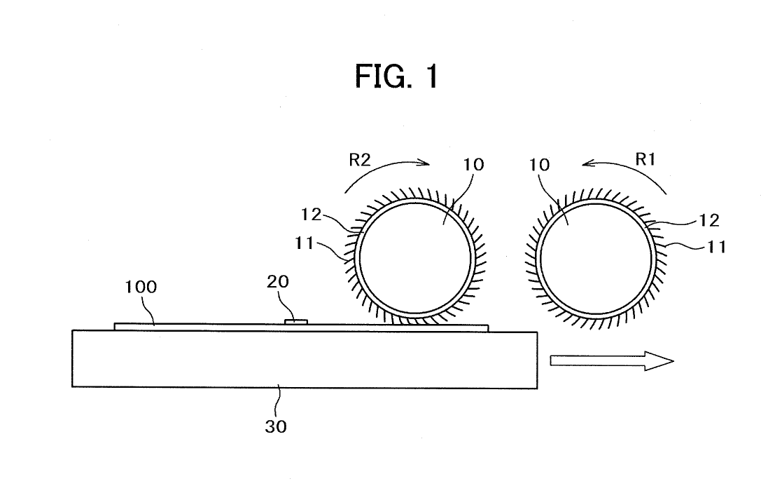

FIG. 1 is a schematic drawing showing a rubbing step according to an embodiment of the present invention. In FIG. 1, a TFT substrate 100 is placed on a rubbing stage 30. The TFT substrate 100 has asperities represented by TFT wiring 20. The TFT wiring 20 represents asperities and does not indicate a specific wire. In FIG. 1, an alignment layer 109 is omitted. The rubbing stage 30 having the TFT substrate 100 moves at, e.g., 30 mm/sec in the direction of a white arrow.

In FIG. 1, two rubbing rollers 10 are disposed to rub the TFT substrate 100. The two rubbing rollers 10 rotate in opposite directions. The two rubbing rollers 10 rotate at, e.g., 1500 rpm. The TFT substrate 100 is first rubbed by the left rubbing roller 10 and then rubbed by the right rubbing roller 10.

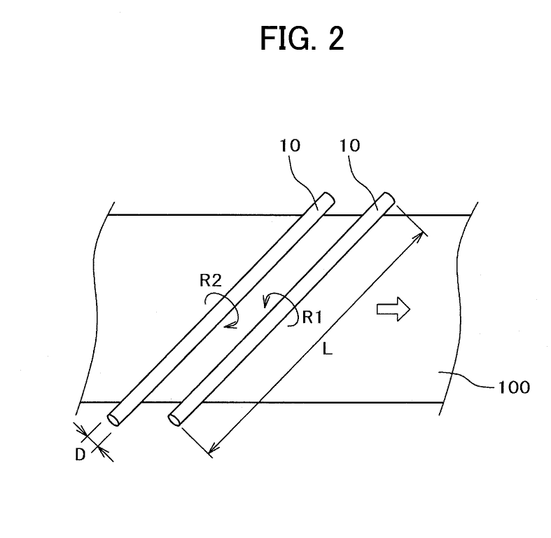

FIG. 2 is a perspective view showing a state of rubbing on the TFT substrate 100. In FIG. 2, the two rubbing rollers 10 are inclined with respect to the TFT substrate 100 in plan view. Thus the initial orientations of liquid crystal molecules are inclined with respect to the sides of the TFT substrate 100. In FIG. 2, for example, the rubbing roller 10 has a diameter of 150 mm and a length L of 1500 mm. As shown in FIG. 2, the TFT substrate 100 is rubbed by the two rubbing rollers 10 while moving in the direction of a white arrow. The two rubbing rollers 10 rotating in different directions are disposed in parallel, so that the liquid crystal molecules are identical in initial orientation.

Referring to FIG. 1 again, the rubbing rollers 10 are each wrapped with a rubbing cloth 12 that has rubbing fibers 11. The orientations of the fibers 11 of the rubbing cloth 12 are optimized with respect to the rotation direction of the rubbing roller 10. The orientations of the fibers 11 of the rubbing clothes 12 are different between the right and left rubbing rollers 10. Each of the rubbing rollers 10 rotates to contact the fibers 11 of the rubbing cloth 12 with the TFT substrate 100. At this point, the fibers 11 of the rubbing cloth 12 on the rubbing roller 10 and the TFT substrate 100 are set so as to form an acute angle.

The fibers 11 of the rubbing cloth 12 are cotton. For example, the fibers 11 are each shaped like an oval having a major axis of 20 μm and a minor axis of 6 μm to 7 μm in cross section. Further, the fibers 11 are about 2.2 mm in length. The length of the rubbing fiber 11 is quite longer than the width or the length of a pixel in a liquid crystal display device, and the diameter of the cross section of the rubbing fiber 11 is substantially equal to the diameter of the pixel. Because of the relationship between a pixel diameter and the diameter or the length of the cross section of the rubbing fiber 11, a rubbing shadow is likely to occur in the presence of asperities on the surface of the TFT substrate 100. The fibers 11 of the rubbing cloth 12 are not limited to cotton but include rayon.

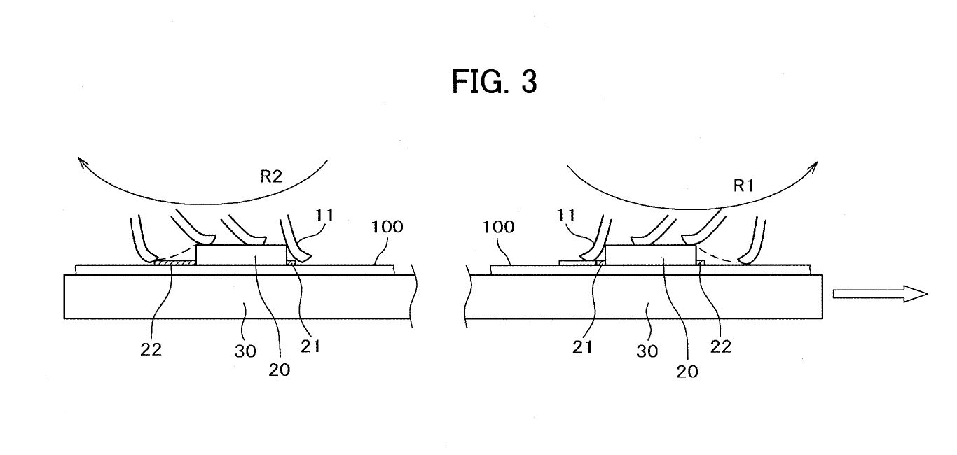

FIG. 3 is a schematic drawing showing the principle of the embodiment of the present invention. In FIG. 3, the TFT substrate 100 is placed on the rubbing stage 30. The TFT wiring 20 is formed on the TFT substrate 100 and causes a rubbing shadow. As shown in the left part of FIG. 3, the TFT substrate 100 is first rubbed by the rubbing roller 10 that rotates in direction R2.

In the left part of FIG. 3, the fibers 11 of the rubbing cloth 12 first rub the right side of the TFT wiring 20. In this case, a rubbing upstream-side shadow 21 is formed on the right side of the TFT wiring 20. The rubbing upstream-side shadow 21 is so small that the TFT substrate 100 is sufficiently rubbed near the rubbing upstream-side shadow 21, whereas a rubbing downstream-side shadow 22 on the left side of the TFT wiring 20 is so large that the TFT substrate 100 is widely unrubbed on the left side of the TFT wiring 20 and the unrubbed part does not allow the initial orientation of liquid crystal molecules.

As the rubbing stage 30 moves in the direction of an arrow, the TFT substrate 100 and the TFT wiring 20 are rubbed by the rubbing roller 10 that rotates in direction R1 in the right part of FIG. 3. The rubbing roller 10 that rotates in direction R1 forms the rubbing upstream-side shadow 21 on the left side of the TFT wiring 20 but the area of the rubbing upstream-side shadow 21 is small. The rubbing roller 10 that rotates in direction R2 in the left part of FIG. 3 forms a large rubbing shadow on the left side of the TFT wiring 20. The large rubbing shadow is located upstream of the rubbing roller 10 that rotates in direction R1 in the right part of FIG. 3, so that the area having been unrubbed by the left rubbing roller 10 is sufficiently rubbed.

The right rubbing roller 10 of FIG. 3 forms the rubbing downstream-side shadow 22 on the right side of the TFT wiring 20, forming a large unrubbed area. However, this part has been already rubbed by the left rubbing roller 10 that rotates in direction R2.

As described above, according to the present invention, the rubbing shadows are extremely small on both sides of the TFT wiring 20 and thus do not affect the orientations of liquid crystal molecules. Therefore, light does not leak from both sides of the TFT wiring 20 in black display.

As shown in FIG. 3, the fibers 11 of the rubbing clothes 12 are oriented in different directions between the right and left rubbing rollers 10. By using the two rubbing rollers 10, the orientations of the fibers 11 of the rubbing cloth 12 can be optimally selected for each of the rubbing rollers 10. It is not particularly necessary to change the rotation speeds of the two rubbing rollers 10. The above example describes the TFT substrate 100 but the principle is also applicable to the counter substrate 200 completely in the same way.

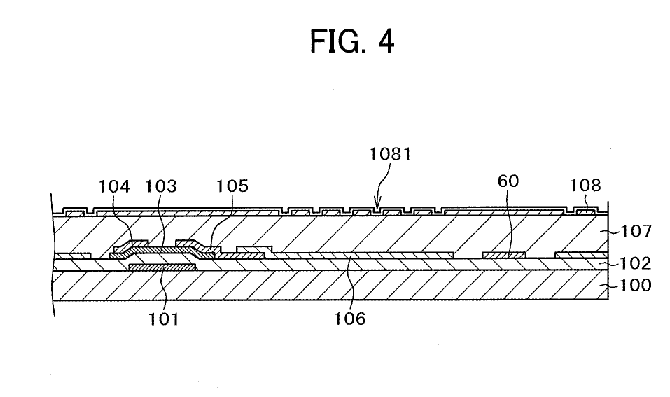

The following will describe the effect of the embodiment of the present invention in various liquid crystal display devices. In the examples of FIGS. 4 to 6, the embodiment of the present invention is effectively applied to in-plane switching (IPS) liquid crystal display devices. Various IPS structures are available and FIG. 4 shows the cross section of the configuration of a TFT substrate according to an example of IPS. In FIG. 4, a gate electrode 101 is formed on a glass TFT substrate 100 and a gate insulating film 102 is formed on the gate electrode 101. Above the gate electrode 101, a semiconductor layer 103 is formed on the gate insulating film 102, and a drain electrode 104 and a source electrode 105 are opposed to each other on the semiconductor layer 103. The TFT is formed in this way.

On the gate insulating film 102, a pixel electrode 106 is formed so as to partially cover the source electrode 105 in plan view. On the gate insulating film 102, a video signal line 60 is formed in the same layer as the source electrode 105 and so on. On the pixel electrode 106, an inorganic passivation film 107 for protecting the TFT is formed and a comb-like counter electrode 108 is formed thereon. On the counter electrode 108, an alignment layer 109 is formed. An electric field between the pixel electrode 106 and the counter electrode 108 rotates liquid crystal molecules and an image is formed by controlling light from a backlight.

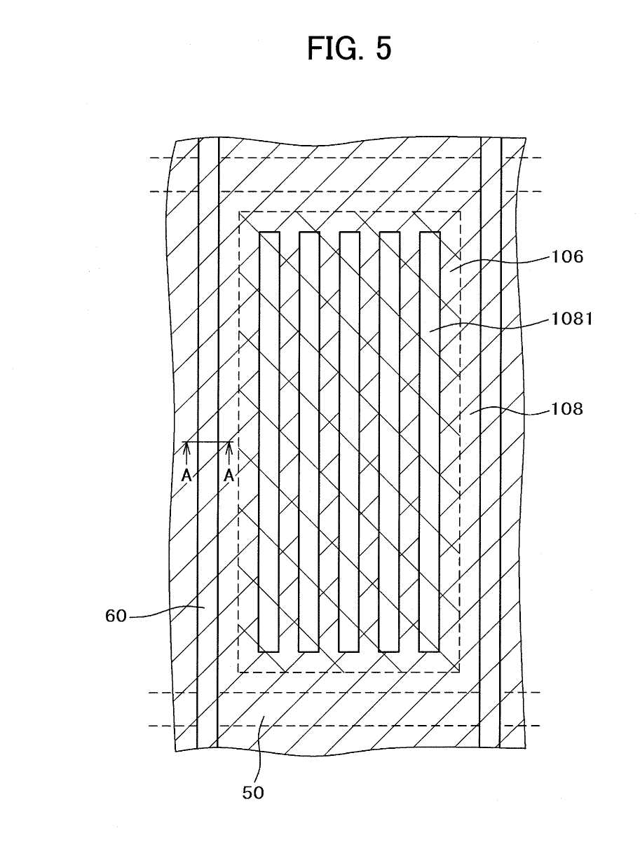

FIG. 5 is a schematic plan view showing a pixel part of FIG. 4. In FIG. 5, a pixel is an area surrounded by scanning lines 50 extended in the horizontal direction and video signal lines 60 extended in the vertical direction. In the pixel area, the pixel electrode 106 is rectangularly formed and the counter electrode 108 cut into a comb shape is formed above the pixel electrode via the inorganic passivation film 107 (not shown). The counter electrode 108 is flat except for comb-teeth portions.

In FIG. 4, recessed portions in the comb-like counter electrode 108 are less subjected to rubbing. In FIG. 5, the recessed portions of the comb-like counter electrode 108 are less subjected to rubbing. The insufficiently rubbed recessed portions lead to a considerable decrease in contrast and a loss of picture quality. The embodiment of the present invention makes it possible to sufficiently rub the recessed portions between comb-teeth electrodes formed in the counter electrode 108, achieving an IPS liquid crystal display device with high picture quality.

In FIG. 4, the semiconductor layer 103 includes an a-Si film, the video signal line 60 is made of metals such as MoCr, and the pixel electrode 106, the counter electrode 108, and any other electrodes are made of indium tin oxide (ITO). The video signal line 60 of FIG. 4 is composed of a single layer.

The video signal line 60 may include an a-Si film, a metal film, and an ITO film to prevent breaks at intersections of the video signal lines 60 and the scanning lines 50. Unlike in FIG. 4, the inorganic passivation film 107 may not be sufficiently thick. In this case, asperities are formed on the surface of the inorganic passivation film 107, at the portions of the video signal lines 60.

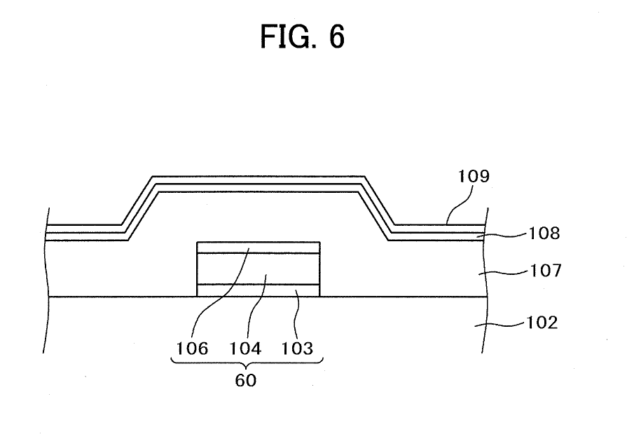

FIG. 6 is a cross-sectional view of the state of FIG. 5. FIG. 6 is a cross-sectional view taken along line A-A of FIG. 5. In FIG. 6, the video signal line 60 including three layers of a-Si, MoCr, and ITO is formed on the gate insulating film 102. The inorganic passivation film 107 is formed on the video signal line 60. The counter electrode 108 is formed on the inorganic passivation film 107 and the alignment layer 109 is formed on the counter electrode 108.

In FIG. 6, the a-Si film 103 has a thickness of 150 nm, the MoCr film 104 has a thickness of 200 nm, the ITO film 106 has a thickness of 70 nm, and the inorganic passivation film 107 has a thickness of about 450 nm, which form asperities on the surface of the alignment layer 109. In the related art, the portions of asperities are not sufficiently rubbed and thus light frequently leaks due to the influence of the rubbing downstream-side shadow 22 on one side of the video signal line 60 shown in FIG. 5. In contrast to the related art, the embodiment of the present invention can prevent leakage of light on both sides of the video signal line 60, thereby fabricating a liquid crystal display device with a high contrast.

In IPS, the comb-like counter electrode 108 is formed on the inorganic passivation film 107 that is an insulating film, and the alignment layer 109 is formed on the counter electrode 108. In addition to the structure of FIG. 4, the comb-like pixel electrode 106 may be formed on the insulating film and the alignment layer 109 may be formed on the pixel electrode 106. The present invention is similarly effective for IPS in such a configuration.

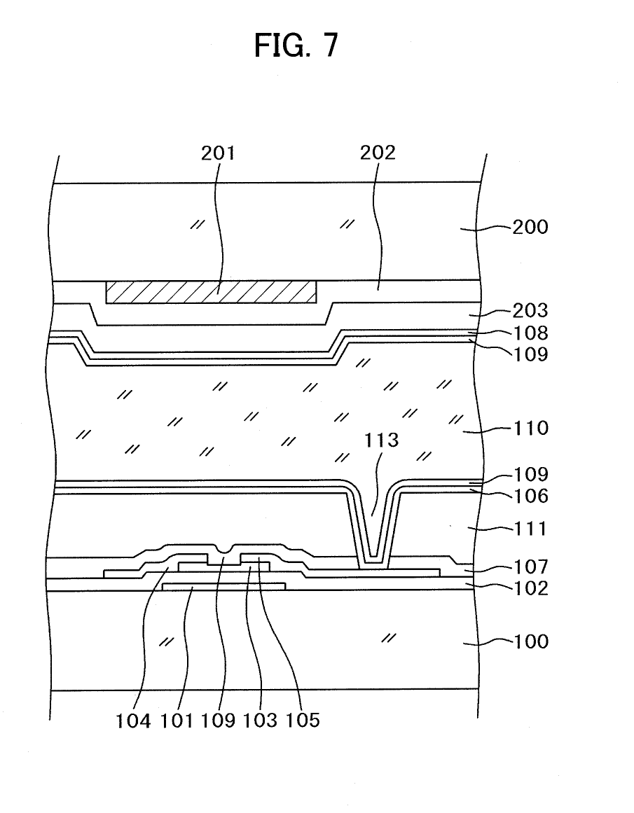

The effect of the present invention has been described above using the example of the TFT substrate 100 of IPS. The present invention is not limited to IPS or the TFT substrate 100 but is also applicable to the counter substrate 200. FIG. 7 is a cross-sectional view showing a typical TN (Twisted Nematic) liquid crystal display device. In FIG. 7, the configuration of a TFT on the TFT substrate 100 is identical to that of FIG. 4.

In FIG. 7, the inorganic passivation film 107 is formed over the TFT and an organic passivation film 111 serving as a planarization film is formed on the inorganic passivation film. The pixel electrode 106 is formed on the organic passivation film 111, and the alignment layer 109 is formed on the pixel electrode 106. In the organic passivation film 111 and the inorganic passivation film 107, a through hole is formed to electrically connect the pixel electrode 106 and the source electrode 105 of the TFT. In FIG. 7, since the organic passivation film 111 is formed on the TFT substrate 100, the alignment layer 109 has a relatively flat surface.

In FIG. 7, the counter substrate 200 is disposed on the TFT substrate 100 with the liquid crystal layer 111 interposed between the substrates. On the counter substrate, a black matrix 201, a color filter 202, and an overcoat 203 are sequentially formed. On the overcoat 203, the counter electrode 108 and the alignment layer 109 are formed. The black matrix 201 and the color filter 202 are laminated. In many cases, the black matrix 201 is made of an organic material and has a thickness of at least 1 μm. Thus, as shown in FIG. 7, steps are formed on both sides of the black matrix 201.

In the related art, steps on both sides of the black matrix 201 are not sufficiently rubbed and light frequently leaks on one side of the black matrix 201 due to the influence of the rubbing downstream-side shadow 22. By applying the embodiment of the present invention to the counter substrate 200, it is possible to sufficiently rub both sides of the black matrix 201, thereby fabricating a liquid crystal display device without light leakage.

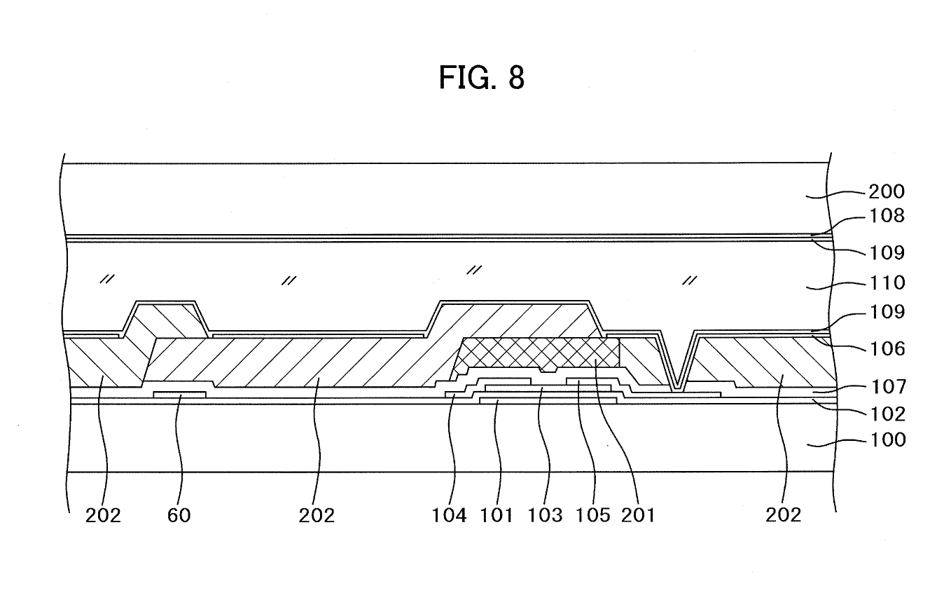

In the liquid crystal display device of the related art, the pixel electrode 106 and the TFT are formed on the TFT substrate 100 and the color filter 202 is formed on the counter substrate 200. In this configuration, unfortunately, it is necessary to precisely align the counter substrate 200 having the color filter 202 and the TFT substrate 100 having the pixel electrode 106, leading to problems of an operating time and yields. Thus, in a structure developed as shown in FIG. 8, the color filters 202 are formed on the TFT substrate 100 by photolithography to reduce the burden of aligning the TFT substrate 100 and a counter substrate 200.

The process of FIG. 8 is similar to that of FIG. 7 until an inorganic passivation film 107 is formed on a TFT on the TFT substrate 100. In FIG. 8, the color filters 202 are formed on portions containing the organic passivation film 111 on the inorganic passivation film 107. Further, the black matrix 201 is formed on a portion to be protected from light on the TFT, before the color filters 202 are formed. Moreover, a pixel electrode 106 is formed on the color filters 202, and the alignment layer 109 is formed on the pixel electrode 106. On the counter substrate 200, the counter electrode 108 and the alignment layer 109 are sequentially formed.

In FIG. 8, the color filters 202 or the black matrix 201 on the TFT substrate 100 form asperities on the surface of the alignment layer 109. To be specific, in FIG. 8, since the black matrix 201 is formed on the TFT and the color filter 202 is formed over the black matrix 201, steps are formed due to the influence of the thickness of the black matrix 201. Further, steps are formed on the two color filters 202 stacked on the video signal line 60.

These steps are about 1 μm in height. In the related art, such steps are not sufficiently rubbed and light frequently leaks on one side of the step. This is because rubbing is not sufficiently performed on the downstream side of rubbing. Particularly, light leaks around the pixel electrode 106. In contrast to the related art, the application of the embodiment of the present invention to the TFT substrate 100 makes it possible to sufficiently rub both sides of the steps, thereby fabricating a liquid crystal display device with a high contrast without causing light leakage over the pixel.

The above rubbing method may be applied only to the TFT substrate 100 or the counter electrode 108. Alternatively, the rubbing method may be applied to both of the TFT substrate 100 and the counter electrode 108. The application of the rubbing method depends on a state of asperities on the surface of the TFT substrate 100 or the alignment layer 109 of the counter substrate 200 and the rationality of the manufacturing process.

What is claimed is:

1. A manufacturing method of a liquid crystal display device, the liquid crystal display device comprising:
a TFT substrate including a TFT, a pixel electrode, and an alignment layer;
a counter substrate including an alignment layer; and
a liquid crystal layer interposed between the alignment layer of the TFT substrate and the alignment layer of the counter substrate,
the manufacturing method comprising the step of rubbing the alignment layer of the TFT substrate or the alignment layer of the counter substrate twice by contacting the alignment layer of the TFT substrate or the alignment layer of the counter substrate with a first rubbing roller and a second rubbing roller arranged in parallel, the first rubbing roller rotating in a first direction, and the second rubbing roller rotating in a second direction.

2. The manufacturing method of a liquid crystal display device according to claim 1, wherein when the first rubbing roller and the second roller rotate to come into contact with the alignment layer of the TFT substrate or the alignment layer of the counter substrate, fibers of rubbing clothes on the first rubbing roller and the second rubbing roller come into contact with the alignment layer of the TFT substrate or the alignment layer of the counter substrate at an acute angle.

3. The manufacturing method of a liquid crystal display device according to claim 1, wherein the TFT substrate includes a comb-like electrode formed on a surface of an insulating film, and the alignment layer is formed on the comb-like electrode.

4. The manufacturing method of a liquid crystal display device according to claim 1, wherein the liquid crystal display device has a part containing a black matrix formed on the counter substrate and a color filter stacked on the black matrix.

5. The manufacturing method of a liquid crystal display device according to claim 1, wherein the TFT substrate includes the TFT, the pixel electrode, and a color filter.
